(19) United States
(12) Patent Application Publication
(10) Pub. No.: US 2026/0288033 A1
(43) Pub. Date: Sep. 24, 2026

(54) IMAGE FORMING APPARATUS FOR TRANSFERRING A DEVELOPER IMAGE FROM AN IMAGE CARRIER TO A RECORDING MEDIUM

(71) Applicant: CANON KABUSHIKI KAISHA, Tokyo (JP)

(72) Inventor: TAISUKE MINAGAWA, Shizuoka (JP)

(21) Appl. No.: 19/569,972

(22) Filed: Mar. 17, 2026

(30) Foreign Application Priority Data
Mar. 19, 2025 (JP) 2025-045618

(51) Int. Cl. G03G 15/08; G03G 15/06; G03G 15/16; G03G 21/00

(52) U.S. Cl. CPC G03G 15/0844; G03G 15/065; G03G 15/1675; G03G 15/1685; G03G 21/0011

(57) ABSTRACT

An image forming apparatus includes an image carrier, a drive unit, a developing unit, a transfer roller, an application unit, a cleaning unit, and a control unit. The control unit executes a first toner purge process during a non-transfer period. In the first toner purge process, the developing unit forms a developer image on the image carrier, and the application unit applies a transfer voltage of a first polarity to the transfer roller to transfer the developer image to the transfer roller. The application unit continues applying the transfer voltage to the transfer roller in a second period from when the developer image is transferred to the transfer roller until a recording medium reaches the transfer roller. The first polarity is opposite to a charging polarity of the developer.

### BACKGROUND

### Field of the Technology

The present disclosure relates to an image forming apparatus that transfers a developer image from an image carrier to a recording medium.

### Description of the Related Art

In an image forming apparatus of an electrophotographic type, a transfer roller transfers a toner image formed on a photosensitive drum to a recording medium. A transfer bias having an opposite polarity to the polarity of the toner is applied to the transfer roller. When fibers and fillers (hereinafter referred to as paper dust) which are components of the recording medium adhere to the transfer roller, “transfer voids” may occur. Transfer voids are a phenomenon in which the transfer of the toner is insufficient at the surface portion of the transfer roller to which the paper dust adheres. This degrades the quality of the image transferred to the recording medium. According to Japanese Patent Laid-Open No. 2018-025684, a technique is described in which paper dust adhering to a recording medium is removed by a registration roller to suppress paper dust adhering to a transfer roller.

When the recording medium passes through the transfer nip portion between the photosensitive drum and the transfer roller, paper dust peeled off from the recording medium may adhere to the transfer roller. The paper dust is generated after the recording medium passes through the registration roller. Therefore, the registration roller cannot collect the paper dust newly generated at the transfer roller.

### SUMMARY

According to some embodiments of the present disclosure, an image forming apparatus includes an image carrier; a drive unit configured to rotationally drive the image carrier; a developing unit configured to supply developer to the rotationally driven image carrier to form a developer image; a transfer roller configured to transfer the developer image from the rotationally driven image carrier to a recording medium; an application unit configured to apply a voltage of a first polarity or a voltage of a second polarity to the transfer roller; a cleaning unit which is arranged downstream of the transfer roller in a rotational direction of the image carrier and which is in contact with the rotationally driven image carrier to clean a surface of the image carrier; and a control unit configured to control the drive unit, the developing unit, and the application unit. The control unit is further configured to execute a first toner purge process during a non-transfer period in which the developer image is not transferred to the recording medium, and the first toner purge process includes: the drive unit rotationally driving the image carrier; the developing unit forming a developer image on the image carrier; the application unit applying a transfer voltage of the first polarity to the transfer roller so that the developer image is transferred from the image carrier to the transfer roller in a first period that covers a period in which the developer image held by the image carrier is transferred to the transfer roller; and the application unit applying the transfer voltage of the first polarity to the transfer roller in a second period from when the developer image held by the image carrier is transferred to the transfer roller until the recording medium reaches the transfer roller. The first polarity is opposite to the second polarity, which is the charging polarity of the developer.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are diagrams illustrating an image forming apparatus and a process cartridge.

FIG. 2 is a diagram illustrating a controller.

FIGS. 3A to 3D are diagrams illustrating an adhesion mechanism of paper dust to a transfer roller.

FIG. 4 is an enlarged diagram illustrating a cleaning contact portion.

FIGS. 5A and 5B are diagrams illustrating a bias application sequence.

FIG. 6 is a flowchart illustrating a control method of the first embodiment.

FIG. 7 is a diagram illustrating experimental results.

FIG. 8 is a flowchart illustrating a control method of the second embodiment.

FIGS. 9A to 9C are diagrams illustrating experimental results.

FIG. 10 is a diagram illustrating another image forming apparatus.

### DESCRIPTION OF THE EMBODIMENTS

Hereinafter, various exemplary embodiments, features, and aspects will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. First Embodiment

### 1-1. Image Forming Apparatus

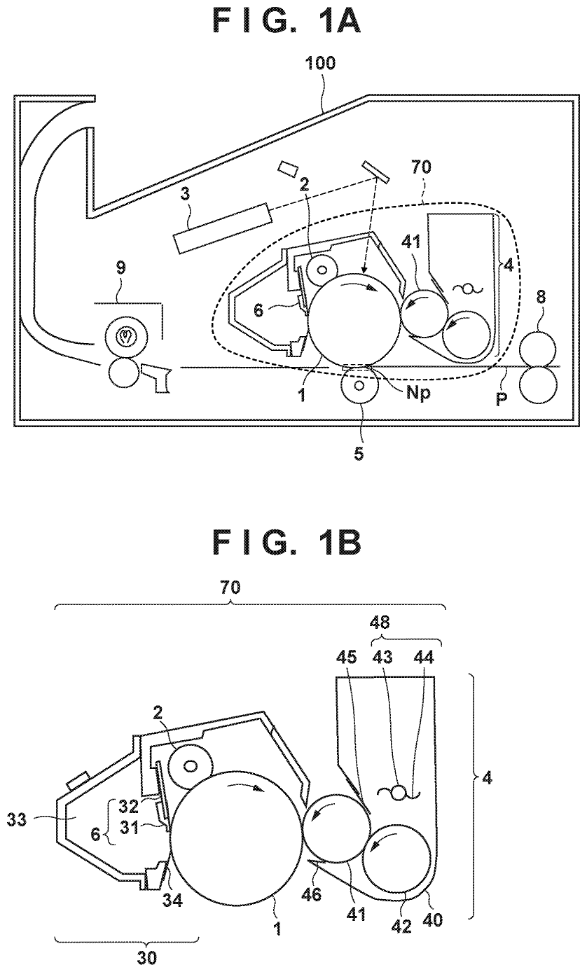

In FIG. 1A, the image forming apparatus 100 is a printer of an electrophotographic type. The image forming apparatus 100 may be commercialized as, for example, a copying machine, a facsimile machine, and a multi-function peripheral (multi-function printer) or the like.

The image forming apparatus 100 includes a process cartridge 70 that is detachable from the image forming apparatus 100. The photosensitive drum 1 is an example of an image carrier that is rotationally driven by a motor or the like. The process cartridge 70 supports the photosensitive drum 1 so that the photosensitive drum 1 can rotate. The charging roller 2 provided in the process cartridge 70 charges the surface of the rotating photosensitive drum 1. A scanner unit 3 is disposed above the process cartridge 70. The scanner unit 3 is an exposure device that forms an electrostatic latent image on the photosensitive drum 1 by irradiating the rotating photosensitive drum 1 with light. The developing roller 41 of the developing device 4 is a developing member that forms a developer image (toner image) by developing an electrostatic latent image using a developer (toner). The transfer roller 5 is a transfer member that rotates in contact with the photosensitive drum 1. A transfer nip is formed between the transfer roller 5 and the photosensitive drum 1. The conveyance roller pair 8 conveys the recording medium P to the transfer nip. When the transfer roller 5 and the photosensitive drum 1 rotate while sandwiching the recording medium P, the toner image is transferred from the photosensitive drum 1 to the recording medium P. A voltage called a transfer bias is applied to the transfer roller 5. The transfer bias promotes transfer of the toner image from the photosensitive drum 1 to the recording medium P. The recording medium P is conveyed to the fixing device 9. The fixing device 9 fixes the toner image on the recording medium P by applying heat and pressure to the recording medium P and the toner image. Thereafter, the recording medium P is discharged to the outside of the image forming apparatus 100.

### 1-2. Process Cartridge

FIG. 1B is a schematic cross-sectional view of the process cartridge 70. The process cartridge 70 includes a cleaning device 30 and a developing device 4. The cleaning device 30 includes the photosensitive drum 1, the charging roller 2, and the cleaning blade 6. The charging roller 2, the developing roller 41, the transfer roller 5, the cleaning blade 6, and the like are disposed around the photosensitive drum 1. However, the transfer roller 5 is provided outside the process cartridge 70. That is, the transfer roller 5 is a component on the main body side of the image forming apparatus 100. The cleaning device 30 includes a cleaning blade 6, a collection chamber 33, and a scoop sheet 34. The cleaning blade 6 includes a rubber blade 31 and a support member 32 that supports the rubber blade 31. The leading end portion of the rubber blade 31 protrudes in a direction counter to the rotational direction of the photosensitive drum 1, and is in contact with the photosensitive drum 1. The collection chamber 33 is a collection container that collects toner and paper dust removed from the surface of the photosensitive drum 1 by the cleaning blade 6. The scoop sheet 34 is in contact with the photosensitive drum 1 so as to prevent the toner stored in the collection chamber 33 from leaking out of the collection chamber 33. When the driving force of a motor, which is a driving source, is transmitted to the cleaning device 30, the photosensitive drum 1 rotates. The charging roller 2 is rotatably attached to the cleaning device 30 and is driven to rotate by the photosensitive drum 1.

The developing device 4 includes a developing frame 40, a developing roller 41, a supply roller 42, a developing blade 45, and a sealing sheet 46. The developing roller 41 is a developing member (rotating body) that rotates in contact with the photosensitive drum 1. The developing frame 40 supports the developing roller 41, the supply roller 42, the developing blade 45, the sealing sheet 46, and the like. The supply roller 42 is disposed around the developing roller 41 and rotates while being in contact with the developing roller 41. Accordingly, the toner is supplied to the surface of the developing roller 41. The developing blade 45 is a regulating member that regulates the thickness of the toner layer on the developing roller 41. Further, the developing blade 45 charges the toner to a negative polarity. A developing bias is applied to the developing roller 41. The developing bias is a voltage that assists the toner negatively charged by triboelectric charging to adhere to the photosensitive drum 1. The toner adheres to a surface that has been exposed by the scanner unit 3 to have a light area potential, and does not adhere to a surface having an unexposed dark area potential. The sealing sheet 46 prevents toner from leaking from the developing frame 40 that is in contact with the developing roller 41.

A toner conveying member 48 is provided in the toner storage chamber 47 of the developing frame 40. The toner conveying member 48 includes a stirring shaft 43 and a sheet member 44. The stirring shaft 43 is rotated by an external driving force and rotates together with the sheet member 44. The sheet member 44 agitates the toner stored in the toner storage chamber 47 and conveys the toner to the supply roller 42.

### 1-3. Controller

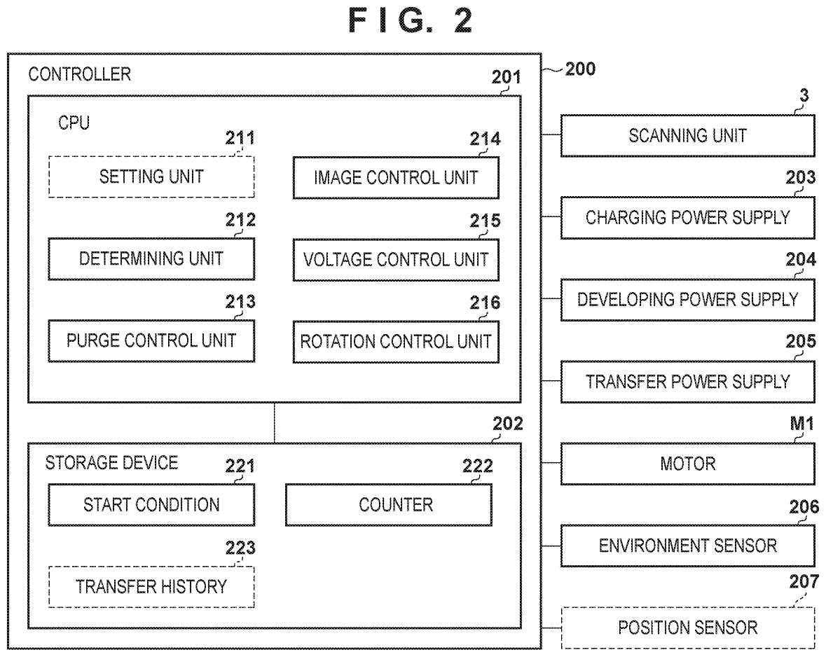

FIG. 2 shows a controller 200 of the image forming apparatus 100. The controller 200 includes a central processing unit (CPU) 201 and a storage device 202. The CPU 201 controls the image forming apparatus 100 by executing a control program stored in the storage device 202. The storage device 202 may include various storage media such as read only memory (ROM), random access memory (RAM), hard disk drive (HDD), and solid state drive (SSD). The CPU 201 realizes a plurality of functions by executing a control program. Part or all of the plurality of functions may be implemented by hardware, such as an application specific integrated circuit (ASIC) or a field-programmable gate array (FPGA).

The setting unit 211 determines or adjusts the start condition 221 based on the environmental condition acquired by the environment sensor 206, the transfer history 223 stored in the storage device 202, or the like, and sets the start condition 221 in the determining unit 212.

The determining unit 212 determines whether or not the start condition 221 of the toner purge is satisfied. The term “toner purge” means that a purge image is formed on the photosensitive drum 1 and the purge image is carried on the photosensitive drum 1 to the cleaning blade 6 in a non-image period in which an image is not formed on the recording medium P. The non-image period may be referred to as a non-print period. This embodiment includes two types of toner purges. The first is a toner purge that forms a lubrication layer on the cleaning blade 6. The second is a toner purge that suppresses adhesion of paper dust to the transfer roller 5. The purge image includes one or more toner patterns that are not transferred to the recording medium P. The density of each toner pattern is constant. The start condition may be that an image defect (streak image) due to an improper lubrication layer is likely to occur, or that paper dust is likely to adhere to the transfer roller 5. The start condition may be that a difference between the cumulative number of printed sheets when the toner purge was executed last time and the cumulative number of printed sheets acquired at the time of the start determination becomes equal to or greater than a threshold value. The start condition may be that the print job has ended.

The purge control unit 213 controls the toner purge. The purge control unit 213 instructs the rotation control unit 216 to rotate the motor M1. The rotation control unit 216 drives the motor M1. Accordingly, the motor M1 rotationally drives the rotating bodies such as the photosensitive drum 1, the developing roller 41, and the transfer roller 5. The purge control unit 213 instructs the voltage control unit 215 to output the charging bias Vd, the developing bias Vdc, and the transfer bias Vtr. In particular, the purge control unit 213 instructs the voltage control unit 215 to output a positive or negative transfer bias Vtr. The voltage control unit 215 causes the charging power supply 203 to output a charging bias Vd. The voltage control unit 215 causes the developing power supply 204 to output a developing bias Vdc. The voltage control unit 215 causes the transfer power supply 205 to output a transfer bias Vtr. The purge control unit 213 instructs the image control unit 214 to form a purge image. The image control unit 214 controls the scanner unit 3 to form an electrostatic latent image of the purge image. Accordingly, the electrostatic latent image reaches the developing roller 41 as the photosensitive drum 1 rotates. The developing roller 41 forms a purge image by applying toner to the photosensitive drum 1. When the photosensitive drum 1 rotates, the purge image reaches the cleaning blade 6 via the transfer roller 5. The cleaning blade 6 cleans off the purge image. Note that, in a case where a positive transfer bias Vtr is applied to the transfer roller 5 as the purge image passes through the transfer roller 5, the toner contained in the purge image is transferred from the photosensitive drum 1 to the transfer roller 5. In a case where a negative transfer bias Vtr is applied to the transfer roller 5 while the purge image passes through the transfer roller 5, the toner contained in the purge image is scarcely transferred from the photosensitive drum 1 to the transfer roller 5. This is because the toner is negatively charged.

The CPU 201 may use a counter 222 that is reset when the toner purge is executed. The counter 222 may be stored in the storage device 202 as a variable holding a count value. If there are multiple toner purges of different types, as described later, a counter 222 may be provided for each toner purge. For example, a counter for counting a numerical value associated with a start condition of a first type of toner purge and a counter for counting a numerical value associated with a start condition of a second type of toner purge may be provided separately. A single counter 222 may be associated with multiple toner purges of different types. In this case, a plurality of thresholds to be compared with the count value of the counter 222 may be prepared.

The storage device 202 may store the start condition 221, the counter 222, and the transfer history 223 in addition to the control program or as a part of the control program. The storage device 202 includes both non-volatile memory and volatile memory. The transfer history 223 may be, for example, a use history of the transfer roller 5 (e.g., cumulative rotation time, cumulative rotation distance), or the like. The transfer history 223 may include information indicating whether the transfer roller 5 is new or old, such as information indicating whether the transfer roller 5 is new, or a wear state of the transfer roller 5. Here, “new” means that the number of times the transfer roller 5 is used for image formation is small. “old” means that the number of times the transfer roller 5 is used for image formation is large.

The position sensor 207 detects the absolute rotational phase of the transfer roller 5 by detecting the home position of the transfer roller 5. That is, the CPU 201 can specify which area of the circumferential surface of the transfer roller 5 is positioned on the transfer nip portion Np based on the detection result of the position sensor 207. When it is desired to transfer the purge image to a particular area of the circumferential surface of the transfer roller 5, the CPU 201 determines the writing timing of the purge image based on the detection result of the position sensor 207. The photosensitive drum 1 and the transfer roller 5 each rotate at a constant rotational speed. The circumferential surface length from the exposure position of the scanner unit 3 to the transfer nip Np with respect to the photosensitive drum 1 is also constant. Therefore, the CPU 201 can form a purge image on a particular area of the circumferential surface of the transfer roller 5.

### 1-4. Transfer Roller Structure and Paper Dust

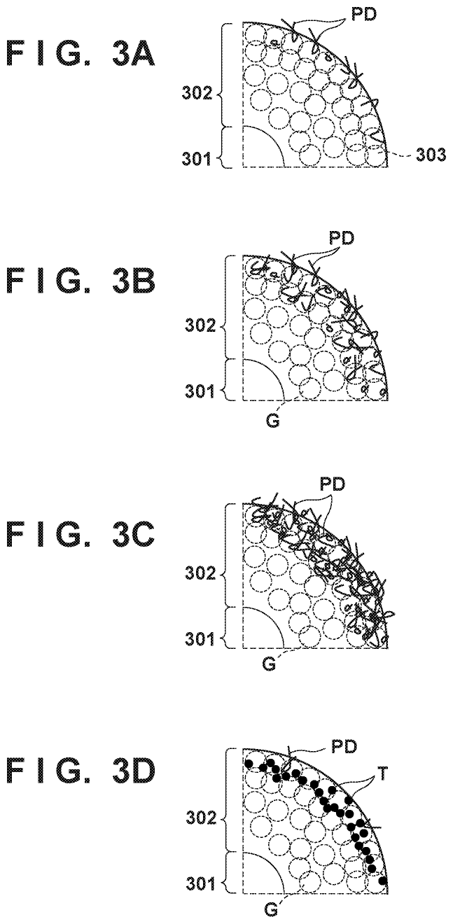

FIG. 3A and FIG. 3D illustrate the construction of the transfer roller 5. The transfer roller 5 includes a core metal 301 and a foamed elastic member 302. The outer diameter of the transfer roller 5 is, for example, 14 millimeter (mm). The outer diameter of the core metal 301 is, for example, 5 mm. The material of the core metal 301 is, for example, stainless steel (SUS). The foamed elastic member 302 is a sponge elastic layer formed on the core metal 301. The foamed elastic member 302 includes a plurality of voids G. The layer thickness of the foamed elastic member 302 is, for example, 4.5 mm. The material of the foamed elastic member 302 is, for example, nitrile rubber (NBR) and hydrin. The resistance value of the transfer roller 5 is, for example, 7.8 LogΩ. The specific materials, dimensions, and resistance values of the transfer roller 5 are merely examples.

FIG. 3A illustrates a state where a small amount of paper dust PD has started to adhere to the new transfer roller 5. It is assumed that the recording medium P is paper. When the recording medium P passes through the transfer nip portion Np, the first surface of the recording medium P comes into contact with the photosensitive drum 1, and the second surface of the recording medium P comes into contact with the transfer roller 5. The second surface of the recording medium P is physically rubbed by the transfer roller 5. Accordingly, the paper dust PD is separated from the recording medium P. The separated paper dust PD adheres to the transfer roller 5. The paper dust PD is polarized under the effect of the transfer bias Vtr, and the polarized paper dust PD may be electrostatically attracted to the transfer roller 5.

As shown in FIG. 3B, as image formation is repeated, more paper dust PD adheres to the transfer roller 5. As paper dust PD increases, a part of the paper dust PD is pushed from the surface of the transfer roller 5 into the transfer roller 5. The foamed elastic member 302 of the transfer roller 5 has a plurality of voids G. Since the plurality of voids G are open cells, adjacent voids G may communicate with each other. Therefore, the paper dust PD can enter the inside of the foamed elastic member 302 through the plurality of voids G.

As shown in FIG. 3C, as image formation is repeated, more paper dust PD adheres to the transfer roller 5. The paper dust PD adheres firmly to the transfer roller 5. When a plurality of paper dust PD particles enter the voids G of the transfer roller 5, the plurality of paper dust PD particles are entangled with each other, and the plurality of paper dust PD particles adhere firmly to the vicinity of the surface of the transfer roller 5. The paper dust PD firmly adhered to the vicinity of the surface of the transfer roller 5 causes the transfer voids.

FIG. 3D illustrates a technique for reducing the adherence of the paper dust PD to the transfer roller 5. In the first embodiment, toner is supplied to the transfer roller 5, and the toner T is filled or inserted into the plurality of voids G. Accordingly, the plurality of voids G communicating with the surface of the transfer roller 5 are blocked by the toner T, so that it is difficult for the paper dust PD to enter the transfer roller 5 through the voids G. Note that the voids G do not need to be completely filled with the toner T. It is sufficient that the toner T is supplied to the voids G before the paper dust PD, so that it is difficult for the paper dust PD to enter the voids G.

In the first embodiment, the process of supplying toner to the transfer roller 5 is referred to as “positive bias purge”. This is because a positive transfer bias Vtr is applied to the transfer roller 5.

The toner particles are negatively charged. When an electric field acts on the charged toner, the toner moves. That is, when a negative transfer bias Vtr is applied to the transfer roller 5, the toner receives a Coulomb force from the transfer roller 5 toward the photosensitive drum 1. After the toner enters the voids G of the transfer roller 5, the paper dust PD may enter the voids G. When the negative transfer bias Vtr is applied, the paper dust PD is electrostatically removed from the transfer roller 5 carried away along with the toner T. As described above, the process of cleaning the paper dust PD by applying a negative transfer bias Vtr to the transfer roller 5 during the non-image period is referred to as “transfer cleaning”.

### 1-5. Formation of Lubrication Layer by Toner Purge

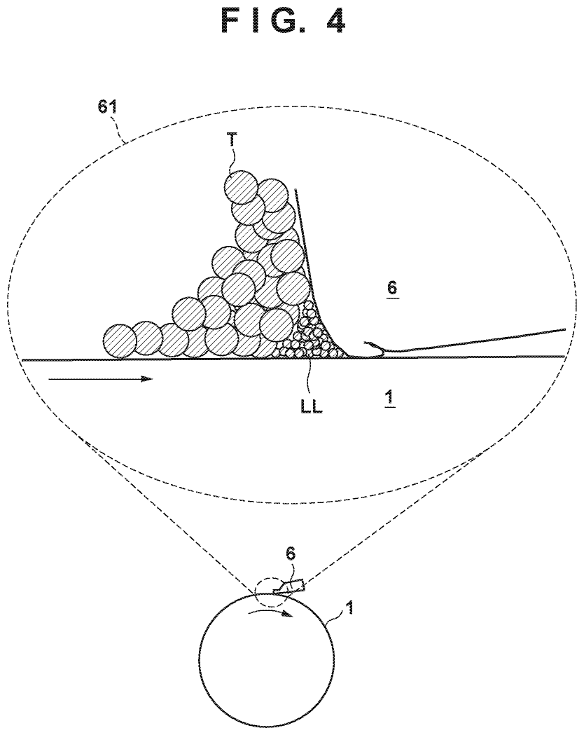

FIG. 4 is an enlarged view of the cleaning contact portion 61. The cleaning contact portion 61 is a contact portion between the cleaning blade 6 and the photosensitive drum 1. The CPU 201 forms the lubrication layer LL on the cleaning blade 6 by supplying the toner T onto the photosensitive drum 1 during the non-image period.

As described above, the transfer residual material on the photosensitive drum 1 is cleaned by using the cleaning blade 6 that abuts the photosensitive drum 1. The leading end portion (rubber blade 31) of the cleaning blade 6 that comes into contact with the photosensitive drum 1 is formed of an elastic body. A frictional force acts on the cleaning contact portion 61. If the frictional force is large, the elastic body of the cleaning blade 6 may be curled or chipped. Therefore, the toner is supplied to the cleaning contact portion 61 during the non-image period. Accordingly, external additives (additive particles) such as silica present on the surface of the toner T are transferred from the developing device 4 to the photosensitive drum 1, and the external additive is conveyed to the leading end portion of the cleaning blade 6 by the photosensitive drum 1. Accordingly, the lubrication layer LL serving as the barrier layer is formed.

By providing the lubrication layer LL, the frictional force acting between the cleaning blade 6 and the photosensitive drum 1 is reduced. Accordingly, the curling and chipping of the cleaning blade 6 are suppressed, and the cleaning performance of the cleaning blade 6 is maintained. Specifically, conveyance of the toner and paper dust adhering to the photosensitive drum 1 to the charging roller 2 is suppressed.

Here, the non-image period refers to a period in which the recording medium P does not pass through the transfer nip portion. For example, the non-image period includes a pre-multi-rotation period, a pre-rotation period, an inter-sheet process period, a post-rotation period, and a standby period.

The pre-multi-rotation period is a start-up operation period (boot-up operation period, warming period) of the image forming apparatus 100, and is a period in which the motor M1 rotationally drives the photosensitive drum 1 and a predetermined preparatory operation is executed. The pre-multi-rotation is executed when the power supply of the image forming apparatus 100 is switched from off to on, or the maintenance door of the image forming apparatus 100 is opened or closed.

The pre-rotation is a step that is executed subsequent to the pre-multi-rotation when the print start signal is input in the pre-multi-rotation period. When there is no input of the print start signal and the pre-multi-rotation period ends, the rotational driving of the photosensitive drum 1 is stopped, and the image forming apparatus 100 is maintained in a stopped state until the print start signal is input. When the print start signal is inputted in the stopped state, the motor M1 is restarted, the photosensitive drum 1 rotates, and the pre-rotation is executed.

The inter-sheet process is a process executed when an image is continuously printed on a plurality of recording media P. The sheet interval refers to a period from when the rear end portion of the recording medium P passes through the transfer roller 5 to when the leading end portion of the next recording medium P reaches the transfer roller 5. That is, the sheet interval is a period in which the recording media P do not pass by the transfer roller 5 in a print job in which an image is continuously printed on the plurality of recording media P.

The post-rotation period is a period in which a predetermined post-operation (post-rotation) is executed. The post-rotation means that the photosensitive drum 1 continues to rotate even after the printing on the last recording medium P in the print job is completed.

The standby period is a period in which the post-rotation is completed and the rotational driving of the photosensitive drum 1 is stopped. In the standby period, the image forming apparatus 100 waits for the next print start signal to be input.

Incidentally, the toner purge may be executed each time the number of printed sheets becomes equal to or greater than the threshold value. For example, the toner purge is executed in the first non-image period (e.g., a post-rotation period and an inter-sheet process period) that occurs after the number of printed sheets becomes equal to or greater than the threshold value. The start conditions of the toner purge may be relaxed as the environmental conditions are more severe. In other words, the setting unit 211 may adjust the start condition such that the execution frequency of the toner purge is increased as the environmental condition is more severe. In addition, the setting unit 211 may adjust the start condition such that the execution frequency of the toner purge decreases as the cumulative number of printed sheets (use history) of the image forming apparatus 100 increases. Note that the start condition may be adjusted according to the usage rate of the photosensitive drum 1 calculated from the rotation time and the charging time of the photosensitive drum 1.

### 1-6. Negative Bias Purge and Positive Bias Purge

In the first embodiment, a plurality of toner purges are switched in accordance with the number of printed sheets or the like and used. All of the plurality of toner purges are executed in the non-image period. Note that the toner purge executed in the period in which the post-rotation is executed may be referred to as the post-rotation purge. As described above, the toner purge can be executed in any non-image period.

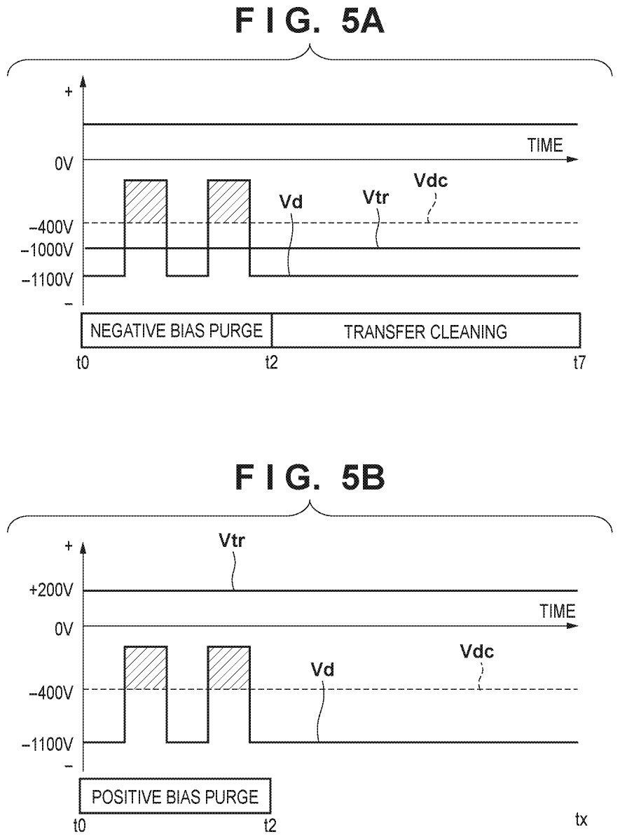

FIG. 5A shows a negative bias purge (first sequence) with transfer cleaning. FIG. 5B shows a positive bias purge (second sequence) without transfer cleaning. The vertical axis represents voltage. The horizontal axis indicates time. The origin on the horizontal axis indicates the start timing of the toner purge. For example, the start timing of the post-rotation purge is the timing at which the image formation is completed. Vdc indicates the developing bias. Vtr indicates the transfer bias. Vd indicates the charging bias. The hatched portion indicates a period during which the purge image comes into contact with the transfer roller 5.

As shown in FIG. 5A, the first sequence has a “negative bias purge” and “transfer cleaning”. The negative bias purge is executed during a period from time t0 to time t2. The transfer cleaning is executed during a period from time t2 to time t7. The negative bias purge is a toner purge using a negative transfer bias Vtr. The negative bias purge is executed primarily to form or reinforce the lubrication layer LL. The transfer cleaning refers to rotating the photosensitive drum 1 and the transfer roller 5 in a state where the purge image is not carried on the photosensitive drum 1. Accordingly, the toner excessively adhering to the transfer roller 5 is conveyed to the cleaning blade 6 by the photosensitive drum 1 and is cleaned.

When the CPU 201 starts the first sequence, it forms a purge image on the photosensitive drum 1 by an image forming operation including charging, exposure, development, and transfer. The purge image includes, for example, two toner patterns. The length of the toner patterns in the sub-scanning direction is, for example, 2 mm. Assuming that the circumferential length of the transfer roller 5 is 44 mm, the distance between the two toner patterns is 42 mm. The length and distance of the toner patterns may be changed according to the amount of toner T used to fill the voids G of the transfer roller 5. The length of the toner patterns in the main scanning direction orthogonal to the sub-scanning direction may be equal to the width of the photosensitive drum 1. The width of the photosensitive drum 1 is the length of the photosensitive drum 1 in a direction (main scanning direction) parallel to the rotation axis of the photosensitive drum 1.

The transfer bias Vtr applied to the transfer roller 5 may effectively supply the toner T supplied from the developing device 4 to the cleaning contact portion 61. The polarity of the transfer bias Vtr is negative. The transfer bias Vtr is continuously applied to the transfer roller 5 while the transfer roller 5 rotates two times. Therefore, the length of the period in which the negative bias purge is executed is twice the rotational period Tc of the transfer roller 5 (=2×Tc). When the transfer roller 5 rotates N times, the length of the period in which the negative bias purge is executed is N×Tc. In FIG. 5A and FIG. 5B, the difference between the time ti and the time ti+1 is Tc. Variable i is an integer equal to or greater than 0.

If the polarity of the transfer bias Vtr is negative, the purge image is hardly transferred to the transfer roller 5. However, the toner T may excessively adhere to the transfer roller 5 due to the positive bias purge described later. Therefore, transfer cleaning is used in order to retransfer the excess toner T transferred to the transfer roller 5 to the photosensitive drum 1. In the transfer cleaning, the transfer roller 5 rotates five times while the negative transfer bias Vtr is applied. Therefore, the length of the period in which the transfer cleaning is executed is five times the rotational period Tc of the transfer roller 5 (=5×Tc). When the transfer roller 5 rotates M times, the length of the period in which the transfer cleaning is executed is M×Tc.

The transfer bias Vtr used in the negative bias purge and the transfer cleaning may be set in view of the resistance value of the transfer roller 5, the resistance value of the photosensitive drum 1, and environmental conditions. For example, in an environmental condition where the environmental temperature is 15° C. and the environmental humidity is 10%, the transfer bias Vtr is, for example, −1,000 V. The charging bias Vd is −1,100 V. The developing bias Vdc is −400 V.

As shown in FIG. 5B, the second sequence includes the positive bias purge but does not include the transfer cleaning. The positive bias purge refers to the intentional transfer of the purge image to the transfer roller 5 using a positive transfer bias Vtr. Accordingly, since the toner T is inserted into the voids G, it is difficult for the paper dust PD to enter the voids G. The positive bias purge is executed during a period from time t0 to time t2. The length of the period in which the positive bias purge is executed is twice the rotational period Tc of the transfer roller 5 (=2×Tc). When the transfer roller 5 rotates N times, the length of the period in which the positive bias purge is executed is N×Tc.

In the positive bias purge, application of a positive transfer bias Vtr to the transfer roller 5 is started at time t0. However, the application of the positive transfer bias Vtr may be started at a timing when the leading end of the purge image reaches the transfer nip portion Np. Accordingly, the toner forming the purge image is transferred from the photosensitive drum 1 to the transfer roller 5. The size of the purge image is as previously described in connection with FIG. 5A.

The positive transfer bias Vtr is continuously applied to the transfer roller 5 while the transfer roller 5 rotates twice. Accordingly, the toner forming the purge image is transferred to the transfer roller 5. A specific value of the positive transfer bias Vtr may be set in view of the resistance value of the transfer roller 5, the resistance value of the photosensitive drum 1, and environmental conditions. For example, under environmental conditions where the environmental temperature is 15° C. (degrees Celsius) and the environmental humidity is 10%, the transfer bias Vtr may be +200 V (volts). For example, the charging bias Vd may be −1,100 V and the developing bias Vdc may be −400 V. These numerical values are merely examples, and may be set according to the resistance value of each member and the use environment.

Here, the toner patterns having the same size are formed in the negative bias purge and the positive bias purge. In particular, the length of each toner pattern in the sub-scanning direction is shorter than the circumferential length of the transfer roller 5. Accordingly, downtime of the image forming apparatus 100 is reduced. The downtime is a period during which the user cannot form an image on the recording medium P using the image forming apparatus 100. In order to prevent the paper dust PD from adhering to the transfer roller 5 in the positive bias purge, it is desirable that the toner T is supplied to the entire outer circumferential surface of the transfer roller 5. However, when the toner T is supplied to the entire outer circumferential surface of the transfer roller 5 at a single positive bias purge, the period in which the positive bias purge is executed becomes downtime. In order to reduce the downtime, the amount of toner T supplied to the transfer roller 5 during a single positive bias purge is limited. However, when the positive bias purge is executed at an appropriate frequency (for example, every predetermined number of printed sheets), a sufficient amount of toner T is supplied to the entire outer circumferential surface of the transfer roller 5.

The CPU 201 adjusts the position at which the purge images are formed with respect to the position of the outer circumferential surface of the transfer roller 5 acquired by the position sensor 207, so that the toner T can be supplied substantially uniformly to the outer circumferential surface of the transfer roller 5.

Incidentally, when the toner T is excessively supplied to the transfer roller 5, “backside contamination” may occur. The backside contamination is a phenomenon in which toner is transferred from the transfer roller 5 to the second surface of the recording medium P. When a large amount of toner T adheres to the transfer roller 5 at one time in the positive bias purge, backside contamination occurs at the time of forming an image immediately after. In order to reduce backside contamination, the amount of toner T supplied to the transfer roller 5 during the positive bias purge is limited.

The size of the toner pattern described above is merely an example. The amount of toner T supplied to the transfer roller 5 by the positive bias purge may be determined so that the downtime is within an allowable range and the backside contamination is less likely to occur. The CPU 201 may determine the size of the toner pattern depending on the size of the recording medium P, the sheet feeding condition, the use environment, the use state of the process cartridge 70, and the use state of the image forming apparatus 100. Specifically, the amount of toner T consumed to form the toner pattern, the number of toner patterns, the length of the toner patterns in the sub-scanning direction, and the supply ratio of the toner T in the main scanning direction may be changed. Here, the sheet feeding condition includes the number of consecutively printed sheets, the frequency of intermittent operations, image forming mode (double-sided printing/single-sided printing), and the like. The intermittent operation means that image formation is intermittently repeated because a print job is continuously input or a time interval between a preceding print job and a subsequent print job is short.

In order to suppress adhesion of the paper dust PD, the toner T may continuously be present on the transfer roller 5. If a negative transfer bias Vtr is applied to the transfer roller 5 after the positive bias purge is executed, the toner T returns from the transfer roller 5 to the photosensitive drum 1. Therefore, the CPU 201 suppresses the negative transfer bias Vtr from being applied to the transfer roller 5 in a period (suppression period) after the positive bias purge is completed. The suppression period is a period from the time t2 to the time tx. The suppression period may be a fixed period or may be a period that can be dynamically changed. In the latter case, when the recording medium P passes through the transfer nip portion Np at a certain frequency or more, the CPU 201 may terminate the suppression period. By providing the suppression period, the toner T is held in the voids G. Consequently, adhesion of the paper dust PD to the transfer roller 5 from the recording medium P passing through the transfer nip portion Np will be suppressed. The certain frequency, which is the end condition of the suppression period, can be set as appropriate in consideration of the use environment or the use state of the image forming apparatus 100. For example, the certain frequency may be set high in a low-temperature and low-humidity environment, and the certain frequency may be set low in a high-temperature and high-humidity environment. As the newer the image forming apparatus 100 is, the certain frequency may be set higher, and as the older the image forming apparatus 100 is, the certain frequency may be set lower.

### 1-7. Flowchart

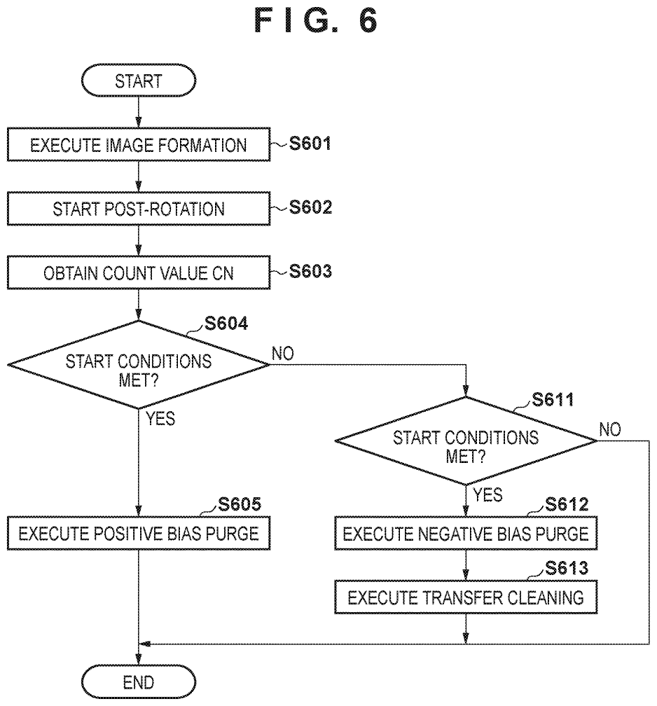

FIG. 6 shows the purge operation of the first embodiment. The CPU 201 executes the following processing in accordance with a control program. Here, the post-rotation period is adopted as the non-image period. When the CPU 201 receives a signal of image formation from a host computer (not shown) or an image reading device (not shown), it starts the following process.

In step S601, the CPU 201 controls the image forming apparatus 100 to execute image formation. Accordingly, an image corresponding to the image signal received from the host computer or the like is formed on the recording medium P.

In step S602, the CPU 201 controls the image forming apparatus 100 to start the post-rotation.

In step S603, the CPU 201 acquires the count value Cn from the counter 222. The count value Cn indicates, for example, the number of printed sheets. The count value Cn may be used to control the frequency of supplying the toner T to the transfer roller 5 (the frequency of executing the positive bias purge). The count value Cn may be used to control the frequency of supplying the toner T for forming the lubrication layer LL (the frequency of executing the negative bias purge). The count value Cn of the counter 222 is reset to zero when a positive bias purge is executed. The CPU 201 adds 1 to the count value Cn each time an image formation is executed.

In step S604, the CPU 201 determines whether a start condition of the positive bias purge is met. For example, the start condition of the positive bias purge may be a condition where the count value Cn becomes equal to or greater than the first threshold value. When the number of images formed after the positive bias purge is executed increases, there is a concern that the paper dust PD adheres to the transfer roller 5. When the start condition of the positive bias purge is met, the CPU 201 proceeds from step S604 to step S605.

In step S605, the CPU 201 executes a positive bias purge. A specific example of the positive bias purge is as described in connection with FIG. 5B. The CPU 201 may ensure the suppression period shown in FIG. 5B after the positive bias purge.

When the start condition of the positive bias purge is not met, the CPU 201 proceeds from step S604 to step S611.

In step S611, the CPU 201 determines whether a start condition of the negative bias purge is met. For example, the start condition of the negative bias purge may be a condition where the count value Cn becomes equal to or greater than the second threshold value. Alternatively, the counter 222 may count the second count value Cn2. The start condition of the negative bias purge may be a condition where the second count value Cn2 becomes equal to or greater than the second threshold value. The second count value Cn2 is reset to zero when the negative bias purge is executed. The CPU 201 adds 1 to the second count value Cn2 each time an image formation is executed. As the number of images formed after the negative bias purge is executed increases, the lubrication layer LL decreases. The negative bias purge and the transfer cleaning may be executed to maintain the lubrication layer LL at a proper level. When the start condition for the negative bias purge is satisfied, the CPU 201 proceeds from step S611 to step S612. When the start condition for the negative bias purge is not satisfied, the CPU 201 skips steps S612 and S613. That is, the negative bias purge is not executed.

In step S612, the CPU 201 executes the negative bias purge. A specific example of the negative bias purge is as described with reference to FIG. 5A.

In step S613, the CPU 201 executes the transfer cleaning. A specific example of the transfer cleaning is as described with reference to FIG. 5A.

The CPU 201 then stops the output of the charging bias Vd, the developing bias Vdc, and the transfer bias Vtr at the appropriate timing. Further, the CPU 201 stops the motor M1 to end the rotation of the photosensitive drum 1.

Here, the toner purge is executed in the post-rotation period, but as already described, the toner purge may be executed in other non-image periods (non-transfer periods). The start condition is a condition based on the number of printed sheets, but this is merely an example. The start condition may be adjusted, for example, in accordance with at least one of a size of the recording medium P, a sheet feeding condition, a use environment, a use state of the process cartridge 70, and a use state of the image forming apparatus 100.

### 1-8. Evaluation Experiment

Evaluation experiments were executed to confirm the effect of the first embodiment. The temperature of the experimental environment was 15° C. and the humidity was 10%. For each print job, an image with a print ratio of 2% was formed on each of the two recording media P. An intermittent printing operation was executed, and single-sided printing was executed on a total of 100,000 recording media P. That is, 50,000 print jobs were executed. Thereafter, the degree of adhesion of the paper dust to the transfer roller 5 was confirmed. Next, a solid black image was formed on the recording medium P at a print ratio of 100%, and the degree of occurrence of the transfer voids was confirmed. The transfer bias Vtr applied to the transfer roller 5 during image formation was +3000 V. As the recording medium P, RedLabel (basis weight 80 g/m² (grams per meter squared), manufactured by Canon) was selected.

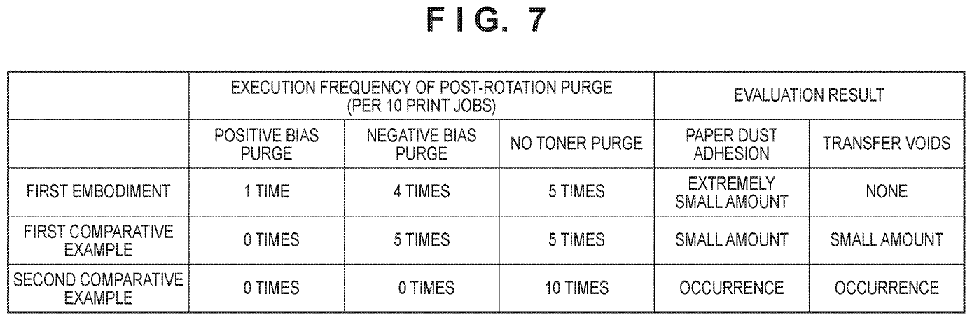

FIG. 7 shows experimental results. In the first embodiment, one positive bias purge and four times negative bias purges were executed per 10 print jobs. In the remaining five print jobs, the toner purge was not executed. In the first comparative example, 0 times positive bias purges and 5 times negative bias purges were executed per 10 print jobs. No toner purge was executed in the remaining 5 print jobs. In the second comparative example, neither the positive bias purge nor the negative bias purge was executed per 10 print jobs.

As described above, ten print jobs constitute one cycle. In the first embodiment, a positive bias purge was executed in the first print job. No toner purge was executed in the second print job. The negative bias purge was executed in the third print job. No toner purge was executed in the fourth, sixth, eighth, and tenth print jobs. The negative bias purge was executed in the fifth, seventh, and ninth print jobs. In the 11th and subsequent print jobs, this cycle was repeated. Note that, the negative bias purge was accompanied by transfer cleaning.

In the first embodiment, the positive bias purge was executed according to a certain rule. Therefore, adhesion of the paper dust PD to the transfer roller 5 was suppressed. Furthermore, since the negative bias purge and the transfer cleaning were executed in accordance with a certain rule, the paper dust PD adhering to the transfer roller 5 was cleaned together with the toner T by the photosensitive drum 1 and the cleaning blade 6. Finally, the adhesion of the paper dust PD to the transfer roller 5 was negligible. No transfer voids were observed because the adhesion amount of paper dust PD was small. As described above, good results were confirmed in the first embodiment.

In the first comparative example, the negative bias purge was executed in the odd-numbered print jobs, and the toner purge was not executed in the even-numbered print jobs. In the first comparative example, since the negative bias purge was executed with a certain rule, a slight amount of toner T was supplied to the transfer roller 5. Further, the paper dust PD was cleaned from the transfer roller 5 by the transfer cleaning. In the first comparative example, since the positive bias purge was not executed, a sufficient amount of the toner T was not supplied to the voids G of the transfer roller 5. Therefore, a small amount of paper dust adhered to the transfer roller 5. Since a small amount of paper dust adheres to the transfer roller 5, a slight degree of transfer voids occurred.

In the second comparative example, the toner purge was not executed in any of the print jobs. Therefore, the toner was not supplied to the voids G of the transfer roller 5. Paper dust adhered to the transfer roller 5, and the transfer voids also occurred.

According to the first embodiment, a toner purge for supplying toner to the transfer roller 5 is executed during the non-image period. Accordingly, the toner is inserted into the voids G existing on the surface of the transfer roller 5, and it is difficult for the paper dust PD to enter the voids G. Accordingly, the amount of the paper dust PD adhering to the transfer roller 5 is reduced, and the transfer voids can be suppressed. That is, a good image with reduced transfer voids can be obtained.

### 1-9. Summary

The photosensitive drum 1 is an example of an image carrier. The transfer roller 5 and the foamed elastic member 302 are an example of a foamed elastic member that conveys the recording medium P while nipping the recording medium P in cooperation with the image carrier and transfers the developer image (toner image) carried on the image carrier to the recording medium P. The CPU 201, the process cartridge 70, the transfer power supply 205, and the like function as an insertion unit that inserts a developer (e.g., toner T) into a plurality of voids G exposed on the surface of the foamed elastic member 302 during a time period in which the recording medium P does not pass by the foamed elastic member 302. Accordingly, the adhesion amount of paper dust PD adhering to the transfer roller 5 is reduced.

The transfer power supply 205 functions as a power supply that applies a voltage (e.g., transfer bias Vtr) having a polarity opposite to the charging polarity of the developer (e.g., positive polarity) to the core metal 301 provided below the foamed elastic member 302. As described above, the toner T may be inserted into the voids G by an electrostatic force.

The motor M1 functions as a drive unit for rotationally driving the image carrier. The developing roller 41 functions as a developing unit that supplies a developer to an image carrier that is rotationally driven and forms a developer image. The transfer roller 5 is an example of a transfer roller that transfers a developer image from an image carrier that is rotationally driven to the recording medium P. The transfer power supply 205 functions as an application unit that applies a voltage of a first polarity or a voltage of a second polarity to the transfer roller 5. The cleaning blade 6 is disposed downstream of the transfer roller 5 in the rotational direction of the image carrier, and functions as a cleaning unit that comes into contact with the rotationally driven image carrier and cleans the surface of the image carrier. The controller 200 and the CPU 201 function as control units for controlling the drive unit, the developing unit, and the application unit. The controller 200 and the CPU 201 execute the first toner purge process in a non-transfer period (non-image period) in which the developer image is not transferred to the recording medium P. The first toner purge process includes a drive unit rotationally driving the image carrier and a developing unit forming a developer image on the image carrier. Further, the first toner purge process includes an application unit applying a transfer voltage of the first polarity to the transfer roller so that the developer image is transferred from the image carrier to the transfer roller in a first period that covers a period in which the developer image held by the image carrier is transferred to the transfer roller. The first toner purge process includes an application unit applying a transfer voltage of the first polarity to the transfer roller in a second period of time from when the developer image held by the image carrier is transferred to the transfer roller until the recording medium reaches the transfer roller. The first polarity is an opposite polarity to the second polarity, which is the charging polarity of the developer. Accordingly, the adhesion amount of paper dust adhering to the transfer roller 5 is reduced. Note that, in the first embodiment, the charging polarity of the toner is negative, but the charging polarity of the toner may be positive. In this case, the second polarity is positive and the first polarity is negative. Note that, as illustrated in FIG. 5B, the period from the time t0 to the time t2 is an example of the first period. The period from the time t2 to the time tx is an example of the second period.

As shown in FIG. 5B, the CPU 201 may apply the transfer voltage of the first polarity to the transfer roller 5 in the first period and the second period. Accordingly, the toner T inserted into the voids G of the transfer roller 5 is less likely to be retransferred to the photosensitive drum 1. Further, the backside contamination of the recording medium P will be less likely to occur.

The transfer roller 5 may include a core metal 301 to which a transfer voltage is applied, and a foamed elastic member 302 formed around the core metal 301. The foamed elastic member 302 may have a plurality of voids G. In the first period, the developer forming the developer image is inserted into the plurality of voids G. That is, the toner T is efficiently inserted into the voids G by the voltage of the first polarity.

As shown in FIG. 6, the CPU 201 may be configured to execute a first toner purge process (positive bias purge) when the first start condition is satisfied, and execute a second toner purge process (negative bias purge) when a second start condition differing from the first start condition is satisfied. The second toner purge process includes the drive unit rotationally driving the image carrier during a non-transfer period, and the developing unit forming a developer image on the image carrier. The second toner purge process includes the application unit applying a transfer voltage of a second polarity to the transfer roller 5 during a third period in which the developer image carried on the image carrier passes the transfer roller 5, so that the developer image is not transferred from the image carrier to the transfer roller 5. The second toner purge process includes the cleaning unit cleaning the developer image held on the image carrier in a fourth period after the third period. As shown in FIG. 5A, the period from time t0 to time t2 is an example of the third period. The period from time t2 to time t7 is an example of the fourth period. By executing the negative bias purge, the toner T excessively adhering to the transfer roller 5 is cleaned. Further, by executing the negative bias purge, the lubrication layer LL is properly maintained.

The number of times N (for example, two times) of rotation of the transfer roller 5 in the first period and the third period is smaller than the number of times M (for example, five times) of rotation of the transfer roller in the fourth period. Accordingly, an increase in downtime is suppressed.

As illustrated in FIG. 7, the first start condition and the second start condition may be defined so that the execution frequency of the first toner purge process is lower than the execution frequency of the second toner purge process. Accordingly, downtime is expected to be reduced. Toner consumption will also be reduced.

The length (e.g., 2 mm) of the developer image formed on the image carrier in the first toner purge process may be shorter than the circumferential length (e.g., 44 mm) of the transfer roller 5. Accordingly, toner consumption is expected to be reduced.

The second toner purge process may be executed in order to form or reinforce the lubrication layer LL at the contact portion (cleaning contact portion 61) between the cleaning unit and the image carrier. Accordingly, foreign matter directed toward the charging roller 2 is blocked by the lubrication layer LL. Consequently, the charging roller 2 is less likely to be contaminated by the toner T or the paper dust PD, and streak images are less likely to be generated.

As described with reference to FIGS. 6 and 7, the first start condition and the second start condition may be conditions based on the number of image forming sheets in the image forming apparatus 100. The number of image formations may be referred to as the number of printed sheets. This is because the adhesion amount of the paper dust is increased depending on the number of the recording media P that have passed through the transfer nip portion Np.

The CPU 201 may adjust the timing of forming the developer image based on the rotational phase of the transfer roller 5 so that the developer is uniformly transferred to the entire circumferential surface of the transfer roller 5. The CPU 201 can identify the rotational phase of the transfer roller 5 based on the detection result of the position sensor 207. By adjusting the forming timing of the developer image based on the rotational phase of the transfer roller 5, it is possible to suppress the toner being biased to a specific region on the circumferential surface of the transfer roller 5. That is, the toner T will be supplied uniformly over the entire circumferential surface of the transfer roller 5. For example, in a case where the circumferential surface of the transfer roller 5 is divided into n regions (circumferential surface regions) along the sub-scanning direction, in the i-th positive bias purge, toner may be supplied to the i-th circumferential surface region. Variable i is an integer from 1 to n. Note that toner may be supplied to a plurality of circumferential surface regions by one positive bias purge.

The CPU 201 may limit the quantity of developer constituting the developer image in the first toner purge process. That is, the amount of developer is limited so that the developer is not transferred from the transfer roller 5 to the second surface of the recording medium P when the recording medium P on which the developer image is transferred from the image carrier to the first surface passes between the transfer roller 5 and the image carrier. Accordingly, backside contamination is less likely to occur.

As described in connection with FIG. 5B, the second period from the time t2 to the time tx may continue until a predetermined number of recording media P pass by the transfer roller 5. Accordingly, the amount of toner T accumulated in the voids G is expected to be stabilized.

As described with reference to FIG. 5B, the second period may continue until the recording medium P passes the transfer roller 5 at a predetermined frequency or higher. Accordingly, the amount of toner T accumulated in the voids G is expected to stabilize.

The CPU 201 and the counter 222 may function as a counting unit that counts the number of the recording media P on which the developer image is transferred in the image forming apparatus 100 and resets the count value when the first toner purge process is executed. The CPU 201 may execute the first toner purge process each time the count value is equal to or greater than the threshold value.

The non-transfer period may be an execution period of a preparatory operation (post-rotation) executed after the image forming apparatus 100 finishes image formation. The non-transfer period may be an execution period of a preparatory operation (pre-rotation) executed before the image forming apparatus 100 starts image formation. The non-transfer period may be an execution period of a preparatory operation (inter-sheet process) executed while the image forming apparatus 100 is continuously executing an image forming operation. The non-transfer period may be an execution period of a preparatory operation (pre-multi-rotation) executed when the image forming apparatus 100 starts up.

The CPU 201 may be configured to apply a transfer voltage of a first polarity to the transfer roller 5 so that the developer is inserted from the image carrier into the plurality of voids G present on the surface of the transfer roller during a non-transfer period in which the developer image is not transferred to the recording medium P.

### 2. Second Embodiment

As mentioned in the first embodiment, the start condition of the positive bias purge may be adjusted according to the wear state of the image forming apparatus 100 (e.g., cumulative operation time, cumulative number of printed sheets, and usage count). Since the amount of toner T accumulated in the voids G of the transfer roller 5 gradually increases, the newer the transfer roller 5 is, the smaller the amount of toner T existing in the voids G is. The newer the transfer roller 5 is, the more toner T should be supplied to the transfer roller 5. Accordingly, it is possible to prevent the paper dust PD from adhering to the transfer roller 5 at an early stage. On the other hand, the older the transfer roller 5 is, the smaller the amount of toner T supplied to the transfer roller 5 should be. This is useful in reducing the consumption of the toner T due to the positive bias purge. Further, as the operation time of the transfer roller 5 increases, the number of times of execution of the positive bias purge decreases. That is, the downtime due to the positive bias purge will also gradually decrease.

### 2-1. Flowchart

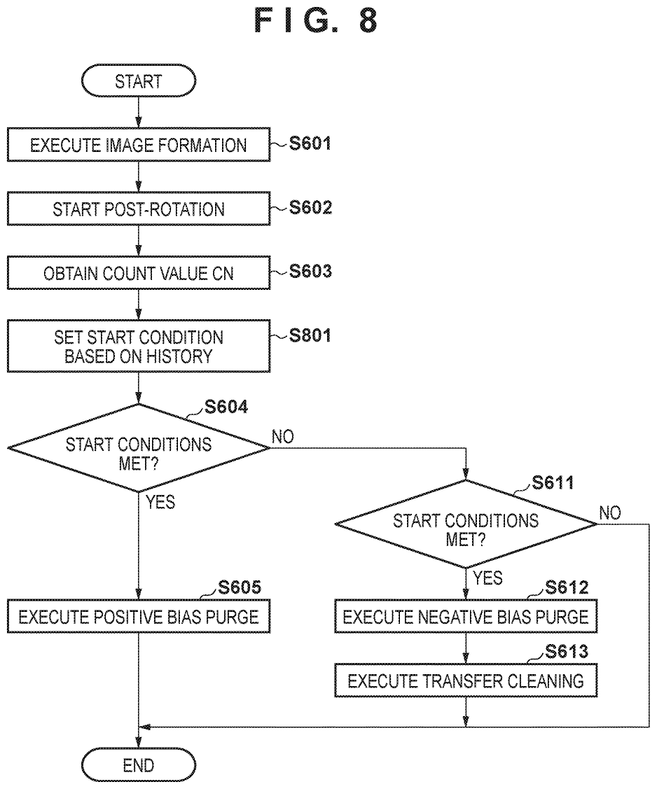

FIG. 8 shows a control method according to a second embodiment. Compared with FIG. 6, in FIG. 8, a step S801 is added between step S603 and step S604. Therefore, step S801 will be described in detail. The description of FIG. 6 is incorporated in the description of the remaining steps.

In step S801, the CPU 201 (setting unit 211) sets the start condition of the positive bias purge based on the history of the image forming apparatus 100. For example, the setting unit 211 may determine the start condition of the positive bias purge based on the transfer history 223 stored in the storage device 202. The transfer history 223 holds the use history of the transfer roller 5 (e.g., cumulative operation time, cumulative number of transfers, cumulative number of image formations, cumulative number of rotations), and the like. If the use history of the transfer roller 5 is zero, it may be determined that the transfer roller 5 is new. When the transfer roller 5 is replaced with a new one, the transfer history 223 may be reset to zero. Accordingly, an accurate transfer history 223 will be maintained. When the user replaces the transfer roller 5, the user may notify the CPU 201 that the transfer roller 5 has been replaced through the operation panel of the image forming apparatus 100. A flag enabling detection of a new state may be attached to the core metal 301 of the transfer roller 5. The CPU 201 may read the flag to determine whether the transfer roller 5 is new.

When the usage count of the transfer roller 5 is small, the setting unit 211 may relax the start condition of the positive bias purge so that the execution frequency of the positive bias purge increases. When the usage count of the transfer roller 5 is high, the setting unit 211 may make the start condition for the positive bias purge stricter so that the execution frequency of the positive bias purge decreases. For example, when the usage count of the transfer roller 5 is small, a small value is set to the first threshold value that is compared with the count value Cn. When the usage count of the transfer roller 5 is high, a large value is set for the first threshold value compared with the count value Cn.

When the usage count of the transfer roller 5 is low, the setting unit 211 may relax the start condition for the negative bias purge so that the execution frequency of the negative bias purge increases. When the usage count of the transfer roller 5 is high, the setting unit 211 may make the start condition for the negative bias purge stricter so that the execution frequency of the negative bias purge decreases. Accordingly, an early build-up of the lubrication layer LL is accomplished. When the usage count of the transfer roller 5 is low, a small value is set for the second threshold value compared with the count value Cn2. When the usage count of the transfer roller 5 is high, a large value is set for the second threshold value compared with the count value Cn2.

### 2-2. Evaluation Experiment

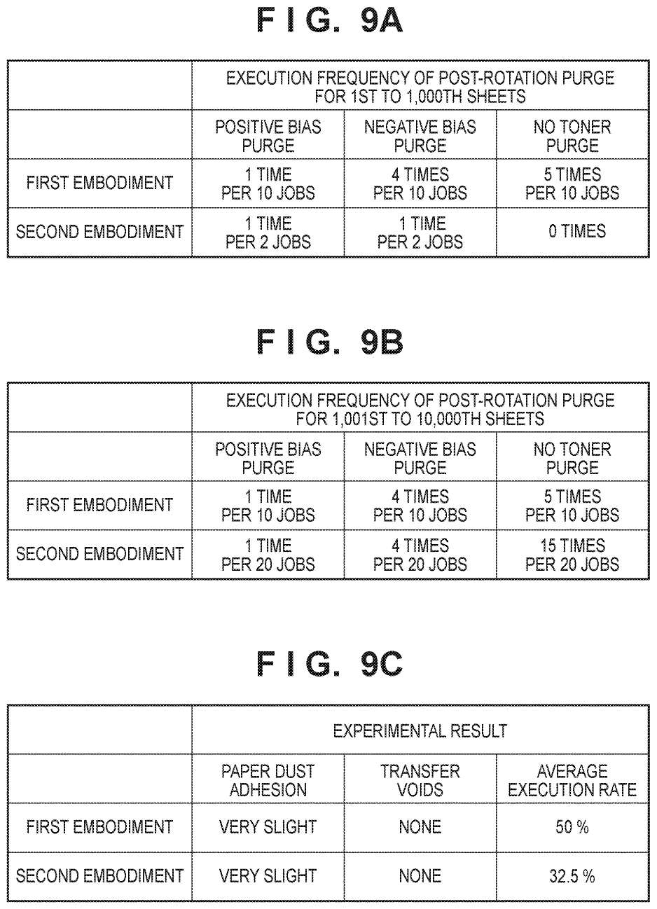

FIG. 9A shows the execution frequency of the toner purge applied to the recording medium P from the first to 1,000th sheet. FIG. 9B shows the execution frequency of the toner purge applied to the 1,001st to 10,000th sheet of the recording medium P. The execution frequency for the first embodiment is as previously described. The same start condition is used from the first sheet to the 10,000th recording medium P.

For the second embodiment, for the recording medium P from the first sheet to 1,000th sheet, the start condition defining two print jobs as one cycle was applied. That is, one positive bias purge was executed in the odd-numbered print jobs. One negative bias purge was executed in the even-numbered print jobs.

For the recording medium P from the 1,001st sheet to the 10,000th sheet, a start condition defining 20 print jobs as one cycle was applied. That is, one positive bias purge was executed per 20 print jobs. Four negative bias purges were executed per 20 print jobs. In 15 out of 20 print jobs, no toner purge was executed.

FIG. 9C shows the experimental results.

According to the execution frequency illustrated in FIGS. 9A and 9B, an image was formed on 100,000 recording media P. The print ratio of the image is as described in connection with FIG. 7.

The execution frequency of toner purge for the first to 10,000th sheet has already been described above. As the execution frequency for 10,001st to 20,000th sheet, the execution frequency of toner purge for the first to 10,000th sheet was reused. The same applies to the execution frequency of toner purge for the 20,001st to 30,000th sheet. That is, the experiment in which 10000 sheets were made to be one cycle was carried out continuously for about 10 times.

As shown in FIG. 9C, the experimental results of the first embodiment are as previously described. That is, the amount of the paper dust PD adhering to the transfer roller 5 was an extremely small amount. No transfer voids were observed. The average execution rate indicates the number of times the toner purge is executed with respect to the total number of print jobs. The average execution rate of the first embodiment was 50%.

In the second embodiment, the newer the transfer roller 5, the more frequently the toner purge is executed. The older the transfer roller 5, the less often the toner purge is executed. In the second embodiment as well, the adhesion amount of toner T adhering to the transfer roller 5 was extremely small. No transfer void occurred. The average implementation rate was 32.5%.

Therefore, the second embodiment exhibits the same effects as those of the first embodiment with respect to the suppression of the paper dust adhesion and the suppression of the transfer voids. Further, the downtime of the second embodiment is less than the downtime of the first embodiment. The toner consumption of the toner purge of the second embodiment is less than the toner consumption of the toner purge of the first embodiment.

According to the second embodiment, the CPU 201 may adjust the first start condition based on the use history of the transfer roller 5. For example, the CPU 201 may adjust the first start condition such that the newer the transfer roller 5, the more frequently the first toner purge process is executed.

The CPU 201 may increase the quantity of developer contained in the developer image formed on the image carrier in the first toner purge process the newer the transfer roller 5 is. According to the second embodiment, the effects described in the first embodiment can be exhibited. Furthermore, the second embodiment may reduce total toner consumption while reducing downtime.

### 3. Modification

According to FIG. 1A, an image forming apparatus 100 for executing monochrome printing using a single process cartridge 70 is shown, but this is only an example. The first embodiment and the second embodiment are applicable to any image forming apparatus configured to allow direct contact between the recording medium P and the transfer roller 5 and capable of supplying toner T to the transfer roller 5. For example, the present disclosure can be applied to a tandem image forming apparatus that forms yellow, magenta, cyan, and black images using four process cartridges and forms a full-color image by superimposing the images. A tandem image forming apparatus transfers a toner image to a recording medium P by an intermediate transfer body (for example, an intermediate transfer belt) and a secondary transfer roller. Therefore, the first embodiment and the second embodiment are applicable to the secondary transfer roller. In this case, the photosensitive drum and the intermediate transfer body correspond to the image carrier.

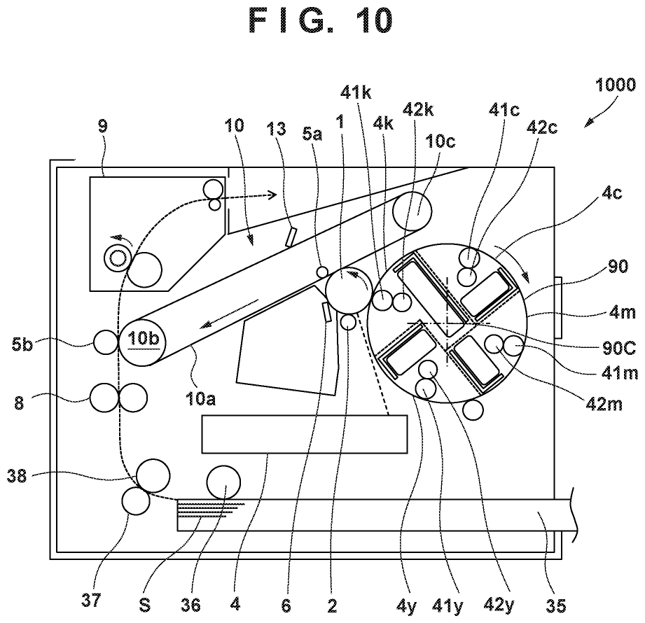

As shown in FIG. 10, the first embodiment and the second embodiment can also be applied to the rotary developing type image forming apparatus 1000. The image forming apparatus 1000 is a printer employing a rotary developing type. It is assumed that the image forming apparatus 1000 is arranged parallel to the horizontal plane. The rotary main body 90 rotates about the rotational axis 90C.

The image forming apparatus 1000 is a laser beam printer that forms an image on the recording medium P by an electrophotographic type. The image forming apparatus 1000 includes four developing devices 4y, 4m, 4c, 4k having different colors. The four developing devices 4y, 4m, 4c, 4k are held by the rotary main body 90. In the present specification, ymck is an abbreviation for yellow, magenta, cyan, and black, respectively. When matters common to ymck are described, ymck characters may be omitted from the reference numerals.

The image forming apparatus 1000 includes an electrophotographic photosensitive member (hereinafter, referred to as the photosensitive drum 1) having a drum shape (cylindrical shape) as an image carrier that carries an electrostatic latent image. The charging roller 2, an exposure device (scanner unit 3), and the cleaning blade 6 are disposed around the photosensitive drum 1.

The charging roller 2 is an example of a charging unit that uniformly charges the surface of the photosensitive drum 1. The scanner unit 3 is an example of an exposure unit that irradiates the photosensitive drum 1 with laser light corresponding to image information to form an electrostatic latent image. The cleaning blade 6 is an example of a cleaning unit that removes toner remaining on the surface of the photosensitive drum 1.

The rotary main body 90 develops the electrostatic latent image by supplying the toner to the photosensitive drum 1, thereby forming a toner image. The transfer roller 5a is a primary transfer roller that transfers the toner image from the photosensitive drum 1 to the intermediate transfer unit 10.

The intermediate transfer unit 10 includes an intermediate transfer belt 10a, a drive roller 10b, a tension roller 10c, a cleaning device 13, and a transfer roller 5a. The intermediate transfer belt 10a is an example of an intermediate transfer body that carries an image transferred from the photosensitive drum 1, conveys the image, and transfers the image to the recording medium P. The intermediate transfer belt 10a is stretched around the drive roller 10b and the tension roller 10c. The drive roller 10b is a drive member that rotationally drives the intermediate transfer belt 10a.

The image forming apparatus 1000 includes a sheet storage unit 35, a pickup roller 36, a feed roller 38, a separation roller 37, a conveyance roller pair 8, a transfer roller 5b, a fixing device 9, and an intermediate transfer unit 10. The sheet storage unit 35 can store a plurality of recording media P. The pickup roller 36 is an example of a feeding unit that feeds the recording medium P from the sheet storage unit 35 to a conveyance path. The feed roller 38 and the separation roller 37 are examples of separation and conveyance units that separate and convey one recording medium P from a plurality of recording media P. The transfer roller 5b is a secondary transfer roller that transfers an image (toner image) from the intermediate transfer belt 10a to the recording medium P.

The fixing device 9 supplies heat and pressure to the toner image and the recording medium P. Accordingly, the toner image is fixed on the recording medium P. Thereafter, the recording medium P is discharged to the outside of the image forming apparatus 1000.

The rotary main body 90 is a rotating body that rotates. The developing devices 4y, 4m, 4c, 4k are supplied with yellow toner, magenta toner, cyan toner, and black toner from a toner cartridge. The developing devices 4y, 4m, 4c, 4k form toner images using yellow toner, magenta toner, cyan toner, and black toner, respectively.

The developing devices 4y, 4m, 4c, 4k include developing rollers 41y, 41m, 41c, 41k and supply rollers 42y, 42m, 42c, 42k, respectively. Each of the supply rollers 42y, 42m, 42c, 42k is a supply member that supplies the toner stored in the developing devices 4y, 4m, 4c, 4k to the developing rollers 41y, 41m, 41c, 41k. Each of the developing rollers 41y, 41m, 41c, 41k is a developer carrying member that carries the toner, rotates, and supplies the toner to the photosensitive drum 1.

The relationship between the transfer roller 5 and the photosensitive drum 1 described in the first embodiment and the second embodiment is applied to the relationship between the transfer roller 5b and the intermediate transfer belt 10a shown in FIG. 10. The structure of the transfer roller 5b is the same as the structure of the transfer roller 5 shown in FIG. 3. By supplying the toner T to the voids G of the transfer roller 5b through the intermediate transfer belt 10a, it is difficult for the paper dust PD to adhere to the voids G of the transfer roller 5b.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-045618, filed Mar. 19, 2025, which is hereby incorporated by reference herein in its entirety.

What is claimed is:

1. An image forming apparatus comprising:
an image carrier;
a drive unit configured to rotationally drive the image carrier;
a developing unit configured to supply developer to the rotationally driven image carrier to form a developer image;
a transfer roller configured to transfer the developer image from the rotationally driven image carrier to a recording medium;
an application unit configured to apply a voltage of a first polarity or a voltage of a second polarity to the transfer roller;
a cleaning unit which is arranged downstream of the transfer roller in a rotational direction of the image carrier and which is in contact with the rotationally driven image carrier to clean a surface of the image carrier; and
a control unit configured to control the drive unit, the developing unit, and the application unit,
wherein the control unit is further configured to execute a first toner purge process during a non-transfer period in which the developer image is not transferred to the recording medium, and the first toner purge process includes:
the drive unit rotationally driving the image carrier;
the developing unit forming a developer image on the image carrier;
the application unit applying a transfer voltage of the first polarity to the transfer roller so that the developer image is transferred from the image carrier to the transfer roller in a first period that covers a period in which the developer image held by the image carrier is transferred to the transfer roller; and
the application unit applying the transfer voltage of the first polarity to the transfer roller in a second period from when the developer image held by the image carrier is transferred to the transfer roller until the recording medium reaches the transfer roller,
wherein the first polarity is opposite to the second polarity, which is the charging polarity of the developer.

2. The image forming apparatus according to claim 1, wherein the control unit is further configured to apply the transfer voltage of the first polarity to the transfer roller in the first period and the second period.

3. The image forming apparatus according to claim 1, wherein the transfer roller includes a core metal to which the transfer voltage is applied, and a foamed elastic member formed around the core metal,
the foamed elastic member has a plurality of voids,
wherein the developer forming the developer image is inserted into the plurality of voids during the first period.

4. The image forming apparatus according to claim 1, wherein the control unit is further configured to:
in a case where a first start condition is satisfied, execute the first toner purge process; and
in a case where a second start condition different from the first start condition is satisfied, execute a second toner purge process,
the second toner purge process, in the non-transfer period, includes:
the drive unit rotationally driving the image carrier;
the developing unit forming a developer image on the image carrier;
the application unit applying a transfer voltage of the second polarity to the transfer roller during a third period that covers a period in which the developer image carried on the image carrier passes the transfer roller, so that the developer image is not transferred from the image carrier to the transfer roller; and
the cleaning unit cleaning the developer image held by the image carrier in a fourth period after the third period.

5. The image forming apparatus according to claim 4, wherein a number N of times that the transfer roller rotates in the first period and the third period is smaller than a number M of times that the transfer roller rotates in the fourth period.

6. The image forming apparatus according to claim 4, wherein the first start condition and the second start condition are defined such that an execution frequency of the first toner purge process is lower than an execution frequency of the second toner purge process.

7. The image forming apparatus according to claim 1, wherein a length of the developer image formed on the image carrier in the first toner purge process is shorter than a circumferential length of the transfer roller.

8. The image forming apparatus according to claim 4, wherein the second toner purge process is executed to form or reinforce a lubrication layer at a contact portion between the cleaning unit and the image carrier.

9. The image forming apparatus according to claim 4, wherein the first start condition and the second start condition are conditions based on the number of images formed in the image forming apparatus.

10. The image forming apparatus according to claim 4, wherein the control unit is further configured to adjust the first start condition based on a history of use of the transfer roller.

11. The image forming apparatus according to claim 4, wherein the control unit is further configured to adjust the first start condition such that the newer the transfer roller is, the more frequently the first toner purge process is executed.

12. The image forming apparatus according to claim 1, wherein the control unit is further configured to increase an amount of developer included in the developer image formed on the image carrier in the first toner purge process, the newer the transfer roller is.

13. The image forming apparatus according to claim 1, wherein the control unit is further configured to adjust a forming timing of the developer image based on a rotational phase of the transfer roller so that the developer is uniformly transferred to an entire circumferential surface of the transfer roller.

14. The image forming apparatus according to claim 1, wherein the control unit is further configured to limit an amount of the developer forming the developer image in the first toner purge process so that the developer is not transferred from the transfer roller to a second surface of the recording medium when the recording medium to which the developer image is transferred from the image carrier to a first surface passes between the transfer roller and the image carrier.

15. The image forming apparatus according to claim 1, wherein the second period continues until a predetermined number of recording media pass by the transfer roller.

16. The image forming apparatus according to claim 1, wherein the second period continues until recording media pass by the transfer roller at a predetermined frequency or higher.

17. The image forming apparatus according to claim 1, wherein the non-transfer period includes at least one of:
an execution period of a preparatory operation executed after the image forming apparatus has finished image formation;
an execution period of a preparatory operation executed before the image forming apparatus starts image formation,
an execution period of a preparatory operation executed while the image forming apparatus continuously executes an image forming operation; or
an execution period of a preparatory operation executed when the image forming apparatus starts up.

18. An image forming apparatus comprising:
an image carrier;
a drive unit configured to rotationally drive the image carrier;
a developing unit configured to supply developer to the rotationally driven image carrier to form a developer image;
a transfer roller configured to transfer the developer image from the rotationally driven image carrier to a recording medium;
an application unit configured to apply a voltage of a first polarity or a voltage of a second polarity to the transfer roller;
a cleaning unit which is arranged downstream of the transfer roller in a rotational direction of the image carrier and which is in contact with the rotationally driven image carrier to clean a surface of the image carrier; and
a control unit configured to control the drive unit, the developing unit, and the application unit,
wherein the control unit is further configured to apply a transfer voltage of the first polarity to the transfer roller during a non-transfer period in which a developer image is not transferred to a recording medium, so that developer is inserted from the image carrier into a plurality of voids existing on a surface of the transfer roller, and
the first polarity is opposite to the second polarity, which is a charging polarity of the developer.

19. An image forming apparatus comprising:
an image carrier;
a foamed elastic member which conveys a recording medium while nipping the recording medium in cooperation with the image carrier and transfers a developer image carried on the image carrier to the recording medium; and
an insertion unit configured to insert a developer into a plurality of voids exposed on a surface of the foamed elastic member during a period in which the recording medium does not pass by the foamed elastic member.

20. The image forming apparatus according to claim 19, wherein the insertion unit includes a power supply that applies a voltage having a polarity opposite to a charging polarity of the developer to a core metal provided in a lower layer of the foamed elastic member.
